(19) United States
(12) Patent Application Publication
(10) Pub. No.: US 2016/0219797 A1
(43) Pub. Date: Aug. 4, 2016

(54) AIR WATER AGRICULTURAL SYSTEM

(71) Applicants: TSINGHUA UNIVERSITY, Beijing (CN); BEIJING TIAN YUAN LAN DE SCIENCE AND TECHNOLOGY LIMITED COMPANY, Beijing (CN)

(72) Inventors: Chaoqing YU, Beijing (CN); Hua YIN, Beijing (CN)

(73) Assignee: BEIJING TIAN YUAN LAN DE SCIENCE AND TECHNOLOGY LIMITED COMPANY, Beijing (CN)

(21) Appl. No.: 15/021,297

(22) PCT Filed: Sep. 12, 2014
(86) PCT No.: PCT/CN2014/086414

§ 371 Date: Mar. 11, 2016

(30) Foreign Application Priority Data
Sep. 12, 2013 (CN) 201310414919.0
Sep. 12, 2013 (CN) 201320566064.9
Oct. 21, 2013 (CN) 201310496072.5
Oct. 21, 2013 (CN) 201320649843.5

(51) Int. Cl. A01G 9/24; B01D 5/00; A01G 9/14; B01D 53/26

(52) U.S. Cl. CPC A01G 9/247; B01D 53/265; B01D 5/0003; A01G 9/14

(57) ABSTRACT

An air water agricultural system includes: an agricultural green house defining an air inlet, an air outlet and a water supply inlet therein; a gaseous water recovery apparatus defining a vapour inlet communicated with the air outlet of the agricultural green house, a vapour outlet, and a liquid water outlet communicated with the water supply inlet of the agricultural green house; and a power source communicated with the gaseous water recovery apparatus.

### CROSS-REFERENCE TO RELATED APPLICATION

This application claims priority to and benefits of Chinese Patent Application Serial Nos. 201310414919.0, 201320566064.9, both filed with the State Intellectual Property Office of P. R. China on Sep. 12, 2013, 201310496072.5 and 201320649843.5, both filed with the State Intellectual Property Office of P. R. China on Oct. 21, 2013, the entire contents of which are incorporated herein by reference.

### FIELD

The present disclosure relates to an agricultural irrigation technology field, especially an air water agricultural system.

### BACKGROUND

In the entire world, the arid and semi-arid regions is about 35% of the total area of the land area, a phenomenon of a seasonal drought is almost in all regions of the world. Due to the maldistribution of precipitation and water sources, a zonal difference of the vegetation distribution on the surface of the Earth is noticeable; the productivity of the ecosystem in desertification or the arid region is low, the development of farming forestry production and social economic is seriously limited by the water source. Currently, in the water supply of the entire world, the vast majority is agricultural water. For example, agricultural water in China is more than 60% of the total water supply, and agricultural water in the northern region is up to 75% of the total water supply. In the process of agricultural production, the vast majority of agricultural water transforms into gaseous water by evaporation and transpiration and is released into the atmosphere. The one-way consumption pattern from liquid water to gaseous water leads to a difficulty in developing the agriculture and other industries in the region with water source shortage.

In the domestic and oversea region with a better condition of natural sources, such as water and heat, because of excessive concentration of population, the source consumption is huge, the environment is seriously damaged, and there will be a big challenge against the sustainability of social economic development. For example, the main grain production region in the east of China suffers from more and more pressure on farmland, water source and environmental pollution, the problem of food security always bothers the survival and development of the country and people.

One way to solve such a problem is to change the one-way water consumption pattern, and to realize water circulation of a scale of the farmland ecosystem, so as to meet the need of water of the agricultural industry with a least water source for a long term. After the problem of the water source has been solved, the desertification or the arid region of China and the world may turn into new farming forestry production bases. At the same time, the renewable energy sources, such as solar energy and wind energy, may be widely used, and the solving of a series of main problems such as energy, food security, desertification, ecological destruction and environmental pollution of current human society are revolutionized, thus truly achieving a sustainable development of the social economy and ecological civilization.

### SUMMARY

Embodiments of the present disclosure seek to solve at least one of the problems existing in the related art to at least some extent. Accordingly, an object of the present disclosure is to provide an air water agricultural system for recycling the water source in the agricultural green house.

The air water agricultural system according to embodiments of the present disclosure includes: an agricultural green house defining an air inlet, an air outlet and a water supply inlet therein; a gaseous water recovery apparatus defining a vapour inlet communicated with the air outlet of the agricultural green house, a vapour outlet, and a liquid water outlet communicated with the water supply inlet of the agricultural green house; and a power source communicated with the gaseous water recovery apparatus.

The air water agricultural system according to embodiments of the present disclosure prevents gaseous water obtained by evaporation and transpiration from entering into free atmosphere directly by the agricultural green house. The gaseous water discharged by the agricultural green house may be recovered by the gaseous water recovery apparatus and liquefied to obtain liquid water, and the liquid water is used again for the growth of plants in the agricultural green house, so as to achieve a cyclic utilization of farmland water in the agricultural green house and complete agricultural production in a condition of less consumption of water resource, thus saving the water resource and protecting the environment.

In addition, the air water agricultural system according to embodiments of the present disclosure may further have additional technical features as follows:

Preferably, the power source is a green energy source.

Specifically, the green energy source is at least one of a solar energy source and a wind energy source.

In some embodiments of the present disclosure, the liquid water outlet of the gaseous water recovery apparatus is communicated with a water reservoir, and a water outlet of the water reservoir is communicated with the water supply inlet of the agricultural green house.

Furthermore, the air water agricultural system further includes a rainwater collector connected with the water reservoir for collecting rainwater. Thus, the energy consumption for running the gaseous water recovery apparatus may be reduced.

In some embodiments of the present disclosure, the gaseous water recovery apparatus includes an air refrigeration device and a liquid water recovery device, the air refrigeration device includes: a casing defining the vapour inlet, the vapour outlet and the liquid water outlet therein; a fan connected with the power source for driving air to flow from the agricultural green house into the casing; a heat exchange device configured to reduce a temperature of air in the casing.

Specifically, the heat exchange device includes: an evaporator disposed in the casing for cooling air in the casing; and a compressor connected with the evaporator and the power source respectively.

Specifically, the heat exchange device includes an air-air heat exchanger defining a cross air duct for performing heat exchange between air discharged from the agricultural green house and cold air.

Specifically, the heat exchange device includes a water-air heat exchanger having an air duct and a water pipe, the air duct is communicated with the casing so as to use low-temperature water in the water pipe of the water-air heat exchanger to reduce a temperature of air discharged from the agricultural green house.

Furthermore, the heat exchange device further includes an underground air duct communicated with the air outlet and the vapour inlet of the casing so as to use ground temperature to directly reduce a temperature of air in the underground air duct.

In other embodiments of the present disclosure, the gaseous water recovery apparatus includes an underground air duct and a liquid water recovery device, the vapour inlet is configured as an entrance of the underground air duct, the vapour outlet is configured as an exit of the underground air duct, the liquid water outlet is formed in the underground air duct, the underground air duct is configured to use ground temperature to directly reduce a temperature of air entering the underground air duct.

In further embodiments of the present disclosure, the gaseous water recovery apparatus further includes a gas-liquid separator, thus ensuring the recovery utilization of the liquid water.

Preferably, the gas-liquid separator is a screen material workpiece.

Specifically, a portion of the water pipe of the water-air heat exchanger extended out of the casing is embedded underground at a predetermined depth so as to use ground temperature to reduce a temperature of water circularly flowing in the water pipe.

In some specific embodiments of the present disclosure, the agricultural green house includes a culture medium, an impermeable layer is provided below the culture medium, the agricultural green house defines a drainage outlet communicated with the water supply inlet of the agricultural green house for discharging liquid water in the culture medium. The impermeable layer in the agricultural green house according to embodiments of the present disclosure is used to prevent water of the culture medium from permeating underground, and the drainage outlet is used to prevent water of the culture medium from being supersaturated; water and nutrient carried from the drainage enter into the agricultural green house again via the water supply inlet of the agricultural green house, thus preventing a loss of the water and an eutrophication of the environment.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic view of an air water agricultural system according to an embodiment of the present disclosure;

FIG. 2 is a schematic view of an air water agricultural system according to a specific embodiment of the present disclosure.

### REFERENCE NUMERALS

air water agricultural system 100, agricultural green house 1, air inlet 10, drainage outlet 13

air outlet 11, water supply inlet 12, gaseous water recovery apparatus 2, vapour inlet 20, vapour outlet 21,

liquid water outlet 22, casing 23,

evaporator 24, compressor 25, water-air heat exchanger 26,

gas-liquid separator 27, air-air heat exchanger 28, fan 31,

underground air duct 30, power source 3, water reservoir 4, water inlet 40,

water outlet 41, rainwater collector water inlet 42,

rainwater collector 6, impermeable layer 7, another water source 8

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom”, “inner”, “outer”, “clockwise”, “anticlockwise” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the description of the present disclosure, unless specified or limited otherwise, it should be noted that, terms “mounted,” “connected” “coupled” and “fastened” may be understood broadly, such as permanent connection or detachable connection, electronic connection or mechanical connection, direct connection or indirect connection via intermediary, inner communication or inter reaction between two elements. These having ordinary skills in the art should understand the specific meanings in the present disclosure according to specific situations.

In the description of the present disclosure, a structure in which a first feature is “on” a second feature may include an embodiment in which the first feature directly contacts the second feature, and may also include an embodiment in which an additional feature is formed between the first feature and the second feature so that the first feature does not directly contact the second feature, unless otherwise specified. Furthermore, a first feature “on,” “above,” or “above” a second feature may include an embodiment in which the first feature is right “on,” “above,” or “above” the second feature, and may also include an embodiment in which the first feature is not right “on,” “above,” or “above” the second feature, or just means that the first feature has a sea level elevation larger than the sea level elevation of the second feature. While first feature “beneath,” “below,” or “on bottom of” a second feature may include an embodiment in which the first feature is right “beneath,” “below,” or “on bottom of” the second feature, and may also include an embodiment in which the first feature is not right “beneath,” “below,” or “on bottom of” the second feature, or just means that the first feature has a sea level elevation smaller than the sea level elevation of the second feature.

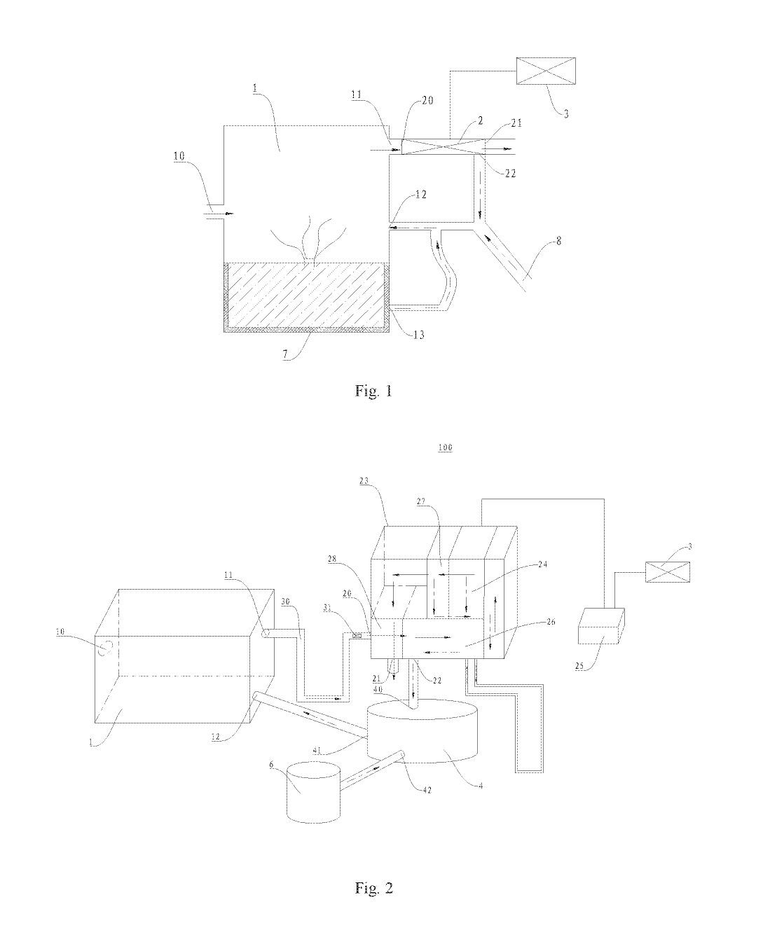

With reference to FIG. 1 and FIG. 2, an air water agricultural system 100 according to embodiments of the present disclosure is described as below, in which the air water is liquid water contained in the air.

The air water agricultural system 100 according to embodiments of the present disclosure, as shown in FIG. 1, includes: an agricultural green house 1, a gaseous water recovery apparatus 2, and a power source 3, in which the agricultural green house 1 defines an air inlet 10, an air outlet 11 and a water supply inlet 12 therein. There are plants in the agricultural green house 1, the agricultural green house 1 may insulate the gaseous water, which is evaporated and transpired from the agricultural green house 1, from natural atmosphere, thus providing necessary condition of recovering and recycling of the gaseous water. The air inlet 10 allows the natural atmosphere to enter to supplement the carbon dioxide and oxygen required by the growth of plants, and to cool the plant growth environment down. Most or all of the air in the agricultural green house 1 is discharged via the air outlet 11, and water can be supplied to the agricultural green house 1 via the water supply inlet 12 to supplement the water required by the growth of plants.

Alternatively, as shown in FIG. 1, an impermeable layer 7 is provided below the culture medium of the agricultural green house 1 to prevent the water of the culture medium to permeate downwardly. The agricultural green house 1 includes a drainage outlet 13 for discharging liquid water of the culture medium, in which the culture environment of the plants in the agricultural green house 1 may be paddy field or arid land. When the culture environment is paddy field, the water exceeding a necessary submerged depth is discharged by the drainage outlet 13 and the necessary submerged depth may be defined specifically according to growth requirements of different plants. When the culture environment is arid land, the supersaturated water of the culture medium is discharged by the drainage outlet 13, so as to prevent the water of the culture medium from being supersaturated. The drainage outlet 13 is communicated with the water supply inlet 12 of the agricultural green house 1, at this time, the water and nutrient carried from the drainage outlet 13 enter into the agricultural green house 1 again via the water supply inlet of the agricultural green house 1, thus preventing a loss of the water and an eutrophication of the environment.

Specifically, the agricultural green house 1 may be a plastic green house or a more perpetual artificial building with a top made of transparent materials like glass, so that sunlight may reach leaves of plants to meet the need of the photosynthesis. More specifically, the top of the agricultural green house 1 may be entirely transparent, obviously, may cover solar energy units partially to make a part of the sunlight reach the leaves of the plants, which not only may meet the need of the photosynthesis, but also may shade the agricultural green house 1 and reduce the temperature of the agricultural green house 1, and electricity generation may also be performed. Furthermore, the top height of the building such as the green house may be adjusted in accordance with the plant height, so as to reduce the air volume in the agricultural green house 1 to improve the recovery rate of the water.

The gaseous water recovery apparatus 2 defines a vapour inlet 20 communicated with the air outlet 11 of the agricultural green house 1, a vapour outlet 21, and a liquid water outlet 22 communicated with the water supply inlet 12 of the agricultural green house 1. Specifically, the gaseous water recovery apparatus 2 is used for recovering and liquefying the gaseous water of the air discharged from the agricultural green house 1, the liquid water collected by the gaseous water recovery apparatus 2 is added into the agricultural green house 1 via the liquid water outlet 22 and the water supply inlet 12, so as to realize the cyclic utilization of production water in the agricultural green house 1.

Specifically, it is important to note that the gaseous water recovery apparatus 2 can be any apparatus, only if the gaseous water entering into the apparatus can be recovered and liquefied to be liquid water at last. It should be understood that, when the environment temperature inside the agricultural green house 1 is higher than the temperature outside the agricultural green house 1, a part of the gaseous water in the agricultural green house 1 may congeal to be liquid water on an inner wall of the agricultural green house 1, in the meantime, the liquid water congealed on the inner wall of the agricultural green house 1 may enter into the gaseous water recovery apparatus 2, that is, the gaseous water recovery apparatus 2 may also recover the liquid water on the inner wall of the agricultural green house 1.

The power source 3 is connected to the gaseous water recovery apparatus 2 to drive the air to flow and drive the gaseous water recovery apparatus 2 to work. That is, the power source 3 drives the air to flow from the agricultural green house 1 to the gaseous water recovery apparatus 2. Preferably, the power source 3 is a green energy source. Alternatively, the green energy source is a solar energy source and/or a wind energy source.

Specifically, the power source 3 drives the gaseous water in the agricultural green house 1 to enter the gaseous water recovery apparatus 2 via the air outlet 11, and drives the gaseous water recovery apparatus 2 to work. The gaseous water entering into the gaseous water recovery apparatus 2 is recovered and liquefied by the gaseous water recovery apparatus 2 to be liquid water at last, and the liquid water in the gaseous water recovery apparatus 2 enters into the agricultural green house 1 via the liquid water outlet 22 and the water supply inlet 12 to complement the water required by the plants. Meanwhile, the air dehumidified by the gaseous water recovery apparatus 2 is discharged to the natural atmosphere. Specifically, by means of conventional irrigation, sprinkler irrigation, drip irrigation, drip irrigation under mulch, etc., the liquid water collected by the gaseous water recovery apparatus 2 is added in the culture medium to supply the water required by the plants.

The air water agricultural system 100 according to embodiments of the present disclosure prevents gaseous water obtained by evaporation and transpiration from entering into free atmosphere by the agricultural green house 1. The gaseous water discharged by the agricultural green house 1 may be recovered by the gaseous water recovery apparatus 2 and liquefied to obtain liquid water, and the liquid water is used again for the growth of plants in the agricultural green house 1, so as to achieve a cyclic utilization of production water in the agricultural green house 1 and complete agricultural production in a condition of less consumption of water resource, thus saving the water resource and protecting the environment.

In some embodiments of the present disclosure, as shown in FIG. 1 and FIG. 2, the air water agricultural system 100 includes a water reservoir 4 defining a water inlet 40 and a water outlet 41. The water inlet 40 of the water reservoir 4 is communicated with the liquid water outlet 22, that is, as indicated by the dashed arrow in FIG. 2, the liquid water discharged from the gaseous water recovery apparatus 2 enters into the water reservoir 4 via the liquid water outlet 22 to be stored. When the plants in the agricultural green house 1 need water supplements, the water in the water reservoir 4 enters into the agriculture green house 1 via the water inlet 41 and the water supply inlet 12.

Furthermore, as shown in FIG. 1 and FIG. 2, the air water agricultural system 100 may also use another water source 8, including rainwater, surface water and underground water. Specifically, the air water agricultural system 100 includes a rainwater collector 6 connected with the water reservoir 4 for collecting rainwater, so as to use for collecting natural rainfall, and further to improve the utilization of the water source. Specifically, as shown in FIG. 1 and FIG. 2, the water reservoir 4 may further include a rainwater collector water inlet 42 and may be connected to a rainwater collector 6 via the rainwater collector water inlet 42.

In some embodiments of the present disclosure, as shown in FIG. 2, the gaseous water recovery apparatus 2 includes an air refrigeration device and a liquid water recovery device. The air refrigeration device includes: a casing 23, a fan 31 and a heat exchange device, in which the casing 23 defines the vapour inlet 20, the vapour outlet 21 and the liquid water outlet 22 therein, the fan 31 is connected with the power source for driving air to flow from the agricultural green house 1 into the casing 23. Preferably, the fan 31 is disposed in the vapour inlet 20. The heat exchange device is configured to reduce a temperature of air in the casing. That is, the air refrigeration device cools the air water therein down to make the temperature of the air water below the dew-point temperature. In the meantime, the gaseous water congeals to be liquid water or even solid water because of the cold, in which it is necessary to convert the liquid water or the solid water into liquid water suitable for the plant growth temperature in any manners, i.e., the gaseous water is liquefied to be liquid water eventually and the liquid water is collected by the liquid water recovery device. It should be understood that the liquid water recovery device can be any devices, only if it can be used for collecting the liquid water.

Specifically, the heat exchange device includes: an evaporator 24 disposed in the casing 23 for cooling air in the casing 23, and a compressor 25 connected with the evaporator 24 and the power source 3 respectively. It is important to note that, the heat exchange device further includes a condenser (not shown) disposed outside the casing 23. Specifically, the compressor 25 defines an exhaust port and a return port, the exhaust port is communicated with an entrance of the condenser, the exit of the condenser is communicated with an entrance of the evaporator 24, and the exit of the evaporator 24 is communicated with the return port. A refrigerant discharged from the exhaust port of the compressor 25 enters into the condenser, and exchanges heat with the air outside the casing 23 to reduce the temperature of the refrigerant in the condenser. The refrigerant discharged from the condenser enters into the evaporator 24, and the refrigerant in the evaporator 24 exchanges heat with the air in the casing 23 to cool the air of the casing 23. The refrigerant discharged from the evaporator 24 comes back to the compressor 25 via the return port to complete one refrigerating cycle.

Specifically, as shown in FIG. 2, the heat exchange device includes an air-air heat exchanger 28 defining a cross air duct for performing heat exchange between air discharged from the agricultural green house 1 and cold air. That is, the air-air heat exchanger 28 is disposed in the casing 23 and may reduce the temperature of the air discharged from the agricultural green house 1. Specifically, the air-air heat exchanger 28 is an air-air heat exchanger 28 in the related art to realize the object to reduce the temperature of the air by cold air. The structure and operation principle of the air-air heat exchanger 28 is already known by those skilled in the related art, which is no more described herein.

Specifically, as shown in FIG. 2, the heat exchange device includes a water-air heat exchanger 26 disposed in the casing 23 and having an air duct and a water pipe, the air duct is communicated with the casing 23 so as to use low-temperature water in the water pipe of the water-air heat exchanger to reduce a temperature of air discharged from the agricultural green house 1. Specifically, low-temperature liquid water flows through the water pipe of the water-air heat exchanger 26, and the air discharged from the agricultural green house 1 enters into the air duct of the water-air heat exchanger 26 to transfer heat with a low-temperature water in the water pipe, so as to reduce the air temperature to form a cold air. Preferably, a part of the water pipe of the water-air heat exchanger 26 extending out from the casing 23 is buried underground at a predetermined depth to use the lower ground temperature to reduce the temperature of water flowing circularly in the water pipe.

Furthermore, as shown in FIG. 2, the heat exchange device further includes an underground air duct 30 with a good thermal conductivity communicated with the air outlet 11 and the vapour inlet 20 of the agricultural green house 1 so as to use the ground temperature to directly reduce a temperature of air in the underground air duct 30, that is, the underground air duct 30 is disposed outside the casing 23 and is buried under ground, and after the air discharged from the agricultural green house 1 enters into the underground air duct 30 to perform a pre-reduction of the temperature, the air is discharged to the casing 23 to further reduce the temperature. It should be understood that a shape of the underground air duct 30 shown in FIG. 2 is illustrative.

In other embodiments of the present disclosure, the gaseous water recovery apparatus 2 includes the underground air duct and the liquid water recovery device, the vapour inlet is configured as an entrance of the underground air duct, the vapour outlet is configured as an exit of the underground air duct, the liquid water outlet is formed in the underground air duct, the underground air duct is configured to use the ground temperature to directly reduce a temperature of air entering the underground air duct to obtain liquid water, and the liquid water recovery device is configured to collect the liquid water obtained by liquefying. That is, only the ground temperature is used to cool the air discharged from the agricultural green house 1 to obtain liquid water.

That is, the gaseous water recovery apparatus 2 according to embodiments of the present disclosure may have the following four refrigerating methods.

A first refrigerating method is forming a refrigerating circulation between the evaporator and the condenser, and between the compressor and the condenser by a refrigerant, so as to realize the object of reducing the temperature of the air discharged from the agricultural green house 1 to the casing 23.

A second refrigerating method: by imbedding the underground air duct 30 under the ground, the air discharged from the agricultural green house 1 may enter the underground air duct 30 to exchange heat with the underground environment, so as to realize the object of reducing the air temperature.

A third refrigerating method: the temperature of the air discharged from the agricultural green house 1 is reduced by using the air-air heat exchanger 28.

A fourth refrigerating method: the temperature of the air discharged from the agricultural green house 1 is reduced by using lower-temperature water with the water-air heat exchanger 26.

In other words, the gaseous water recovery apparatus 2 according to embodiments of the present disclosure has four refrigerating methods, and each of the four methods may be used independently, simultaneously or be used crossly. It should be understood that the refrigerating method described above are illustrative. Thus, the refrigerating methods of the gaseous water recovery apparatus 2 according to embodiments of the present disclosure are diversified to meet different requirements.

In preferred embodiments of the present disclosure, the gaseous water recovery apparatus 2 uses the four refrigerating methods at the same time. As indicated by a solid arrow in FIG. 2, under the effect of the fan 31, the air in the agricultural green house 1 enters the underground air duct 30 via the air outlet 11 to exchange heat with the underground environment in the underground air duct 30 to perform a first temperature reduction. After the first temperature reduction, the air enters the air-air heat exchanger 28 from the underground air duct 30 to exchange heat with the cold air entering into the air-air heat exchanger 28 to perform a second temperature reduction. After the second temperature reduction, the air is discharged from the air-air heat exchanger 28 and enters the air duct of the water-air heat exchanger 26, a lower water temperature of the water pipe of the water-air heat exchanger 26 may be used to reduce the temperature of the air entering into the air duct of the water-air heat exchanger 26 to perform a third temperature reduction. After the third temperature reduction, the air is discharged from the water-air heat exchanger 26 and exchanges heat with the evaporator 24 to perform a fourth temperature reduction, and after the fourth temperature reduction, the air is discharged to the natural atmosphere via the vapour outlet 21. During the process of each temperature reduction, the gaseous water of the air may be congealed to liquid water, and for this time, the four temperature reductions may ensure that most gaseous water is liquefied to liquid water, the liquid water recovery device collects liquid water liquefied during the temperature reduction process.

As shown in FIG. 2, in the flowing direction of the air, the underground air duct 30, the air-air heat exchanger 28, the water-air heat exchanger 26, the evaporator 24 and the gas-liquid separator 27 are provided in turn, the liquid water recovery device includes water troughs disposed at the inner bottom wall of the underground air duct 30, below the air-air heat exchanger 28, below the water-air heat exchanger 26, below the evaporator 24 and below the gas-liquid separator 27 respectively. In the process of every temperature reduction, if there is liquid water, the liquid water will fall into the water trough under the effect of gravity, as indicated by the dashed arrow in FIG. 2, the liquid water flows in the water trough and flows into the water reservoir 4 to be stored eventually.

Specifically, the cold air entering into the air-air heat exchanger 28 as described above may be the cold air in the casing 23, and may also be the cold air of the natural atmosphere to save the energy consumption. Preferably, as indicated by the solid arrow in FIG. 2, the air through four time temperature reductions flows through the gas-liquid separator 27, the gas-liquid separator 27 may intercept the spray of the air, and at last, the air through the gas-liquid separator 27 enters into the air-air heat exchanger 28 to exchange heat with the air through one time temperature reduction, and the air through four time temperature reductions is discharged from the vapour outlet 21 eventually.

In order to prevent the energy consumption, in a further embodiment of the present disclosure, a heat preservation insulation layer is disposed in the casing 23, so as to improve the utilization rate of energy.

When the temperature of the casing 23 is higher than 0 degree centigrade, condensation water liquefied from gaseous water may be in a form of drops with different particle sizes suspending in the air, i.e., suspending in the air in a form of spray, in order to ensure a sufficient recovery of liquid water. In some embodiments of the present disclosure, as shown in FIG. 1 and FIG. 2, the gaseous water recovery apparatus 2 further includes the gas-liquid separator 27, the gas-liquid separator 27 is disposed in the casing 23 to intercept the spray. Preferably, the gas-liquid separator 27 is a screen material workpiece. Alternatively, the gas-liquid separator 27 is a metal screen workpiece, a fiber screen workpiece or a mixed screen workpiece of both. More preferably, the gas-liquid separator 27 is a mixed screen workpiece of metal and glass fiber, so as to reduce cost. Further preferably, the gas-liquid separator 27 is a mixed screen workpiece of steel and glass fiber, i.e., the steel screen and the glass fiber screen are layered and mixed-knit. The steel screen may intercept the spray with a larger particle, and the glass fiber screen with a better hydrophilicity may separate the spray with a smaller particle from the air, so as to adequately collect the liquid water. Obviously, the present disclosure is not limited thereto, and the gas-liquid separator 27 may also be other devices collecting the spray, such as a device with a microfiltration film, a device with a centrifuge achieving gas-liquid separation by the inertia principle or a device with a baffle plate.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. An air water agricultural system, comprising:
an agricultural green house defining an air inlet, an air outlet and a water supply inlet therein;
a gaseous water recovery apparatus defining a vapour inlet communicated with the air outlet of the agricultural green house, a vapour outlet, and a liquid water outlet communicated with the water supply inlet of the agricultural green house; and
a power source communicated with the gaseous water recovery apparatus.

2. The air water agricultural system according to claim 1, wherein the power source is a green energy source.

3. The air water agricultural system according to claim 2, wherein the green energy source is at least one of a solar energy source and a wind energy source.

4. The air water agricultural system according to claim 1, wherein the liquid water outlet of the gaseous water recovery apparatus is communicated with a water reservoir, and a water outlet of the water reservoir is communicated with the water supply inlet of the agricultural green house.

5. The air water agricultural system according to claim 4, wherein the air water agricultural system further comprises a rainwater collector connected with the water reservoir for collecting rainwater.

6. The air water agricultural system according to claim 1, wherein the gaseous water recovery apparatus comprises an air refrigeration device and a liquid water recovery device, the air refrigeration device comprises:
a casing defining the vapour inlet, the vapour outlet and the liquid water outlet therein;
a fan connected with the power source for driving air to flow from the agricultural green house into the casing; and
a heat exchange device configured to reduce a temperature of air in the casing.

7. The air water agricultural system according to claim 6, wherein the heat exchange device comprises:
an evaporator disposed in the casing for cooling air in the casing; and
a compressor connected with the evaporator and the power source respectively.

8. The air water agricultural system according to claim 6, wherein the heat exchange device comprises an air-air heat exchanger defining a cross air duct for performing heat exchange between air discharged from the agricultural green house and cold air.

9. The air water agricultural system according to claim 6, wherein the heat exchange device comprises a water-air heat exchanger having an air duct and a water pipe, the air duct is communicated with the casing so as to use water in the water pipe of the water-air heat exchanger to reduce a temperature of air discharged from the agricultural green house.

10. The air water agricultural system according to claim 7, wherein the heat exchange device further comprises an underground air duct communicated with the air outlet and the vapour inlet of the casing so as to use ground temperature to directly reduce a temperature of air in the underground air duct.

11. The air water agricultural system according to claim 1, wherein the gaseous water recovery apparatus comprises an underground air duct and a liquid water recovery device, the vapour inlet is configured as an entrance of the underground air duct, the vapour outlet is configured as an exit of the underground air duct, the liquid water outlet is formed in the underground air duct, the underground air duct is configured to use ground temperature to directly reduce a temperature of air entering the underground air duct.

12. The air water agricultural system according to claim 1, wherein the gaseous water recovery apparatus further comprises a gas-liquid separator.

13. The air water agricultural system according to claim 12, wherein the gas-liquid is a screen material workpiece.

14. The air water agricultural system according to claim 9, wherein a portion of the water pipe of the water-air heat exchanger extended out of the casing is embedded underground at a predetermined depth so as to use ground temperature to reduce a temperature of water circularly flowing in the water pipe.

15. The air water agricultural system according to claim 1, wherein the agricultural green house comprises a culture medium, an impermeable layer is provided below the culture medium, the agricultural green house defines a drainage outlet communicated with the water supply inlet of the agricultural green house for discharging liquid water in the culture medium.

16. The air water agricultural system according to claim 2, wherein the liquid water outlet of the gaseous water recovery apparatus is communicated with a water reservoir, and a water outlet of the water reservoir is communicated with the water supply inlet of the agricultural green house.

17. The air water agricultural system according to claim 16, wherein the air water agricultural system further comprises a rainwater collector connected with the water reservoir for collecting rainwater.

18. The air water agricultural system according to claim 8, wherein the heat exchange device further comprises an underground air duct communicated with the air outlet and the vapour inlet of the casing so as to use ground temperature to directly reduce a temperature of air in the underground air duct.

19. The air water agricultural system according to claim 9, wherein the heat exchange device further comprises an underground air duct communicated with the air outlet and the vapour inlet of the casing so as to use ground temperature to directly reduce a temperature of air in the underground air duct.
